(19) United States
(12) Patent Application Publication
(10) Pub. No.: US 2012/0308736 A1
(43) Pub. Date: Dec. 6, 2012

(54) METHOD FOR PRODUCING OPTICAL WAVEGUIDE

(75) Inventors: Pei-Hua HU, New Taipei (TW); Hsien-Hui HUANG, New Taipei (TW); Chih-Hui LO, New Taipei (TW); SHih-Chi CHAN, New Taipei (TW); Yu-Min WANG, New Taipei (TW)

(73) Assignee: HON HAI PRECISION INDUSTRY CO., LTD., New Taipei (TW)

(21) Appl. No.: 13/488,383

(22) Filed: Jun. 4, 2012

(30) Foreign Application Priority Data
Jun. 3, 2011 (TW) 100119479

(51) Int. Cl. G02B 6/10

(52) U.S. Cl. 427/510

(57) ABSTRACT

A method for producing an optical waveguide includes following steps: firstly, providing a substrate and coating resins on the substrate to form a clad; secondly, providing a container filled with waveguide material and inject the waveguide material through a nozzle of the container to form a shape needed on the clad; thirdly, shining UV lights on the waveguide material to harden the waveguide material to form the waveguide. This new method uses less waveguide material and simplifies the steps.

### BACKGROUND OF THE INVENTION

1. Field of the Invention

The present invention relates to a method for producing an optical waveguide, and more specifically, to a method for producing an optical waveguide without using many waveguide materials.

2. Description of Related Arts

U.S. Pat. No. 7,847,017 issued on Feb. 24, 2011 discloses an optical waveguide including a substrate and coating resins on the substrate to form a clad, some of waveguide material covering on the clad to form a waveguide layer. Providing a shielding blade defines an opening on the upper region of the waveguide layer and defining UV lights on the upper region of the shielding blade. Shining UV lights on the shielding blade and UV lights pass through the shielding blade to shine on the waveguide layer by the opening. Finally, the waveguide layer aim at the opening forms a waveguide pattern. However, this method of producing a waveguide needs many waveguide materials.

Hence, a method of producing a waveguide without using many waveguide materials is desired.

### SUMMARY OF THE INVENTION

Accordingly, an object of the present invention is to provide a method of producing an optical waveguide without using many waveguide material.

An object of the present invention is to provide a method of producing an optical waveguide. The Method comprises the following steps: (a) providing a substrate and coating resins on the substrate to form a clad; (b) providing a container filled with waveguide material and inject the waveguide material through a nozzle of the container to form a shape needed on the clad; (c) providing UV lights and shining the UV lights on the waveguide material to harden the waveguide material to form the waveguide pattern.

Other objects, advantages and novel features of the invention will become more apparent from the following detailed description when taken in conjunction with the accompanying drawings.

### BRIEF DESCRIPTION OF THE DRAWING

FIG. 1 is a perspective view of a method of producing an optical waveguide without spray painting waveguide materials of the present invention;

FIG. 2 is a perspective view of a method of producing the optical waveguide spray painting waveguide materials of the present invention;

FIG. 3 is a perspective view of a second embodiment of the method of producing the optical waveguide; and

FIG. 4 is a perspective view of a second embodiment of the method of producing the optical waveguide.

### DETAILED DESCRIPTION OF THE PREFERRED EMBODIMENT

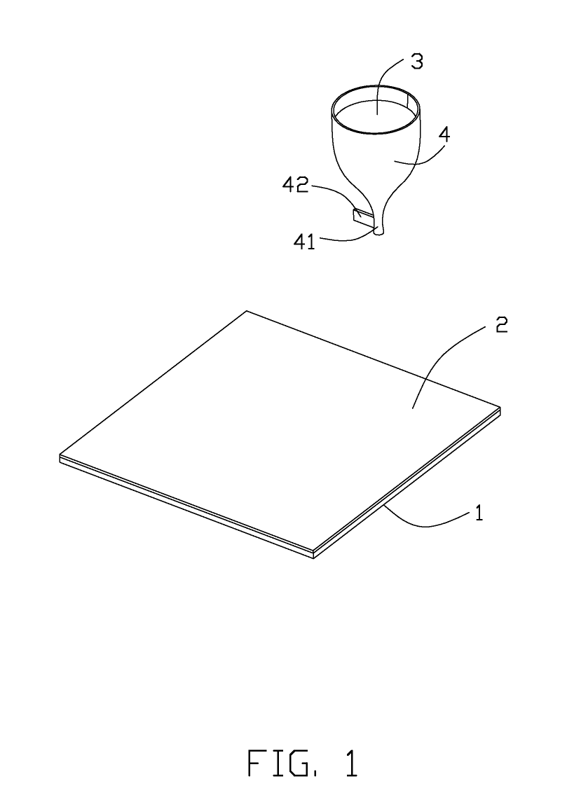

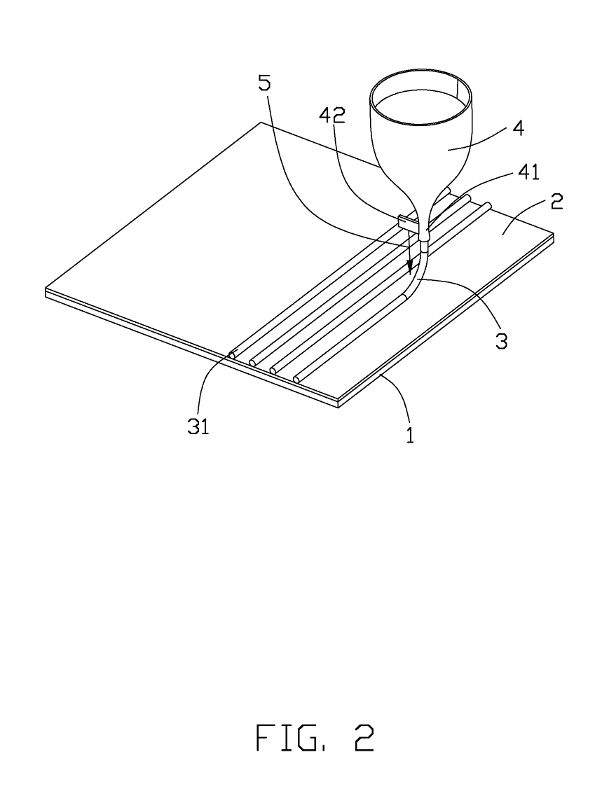

Referring to FIGS. 1-2, a method of producing an optical waveguide, the method need a substrate 1, a clad 2 coating on the substrate 1, some of waveguide material 3 that transmission optical signal, a container 4 filled with waveguide material and UV lights 5 for hardening the waveguide material.

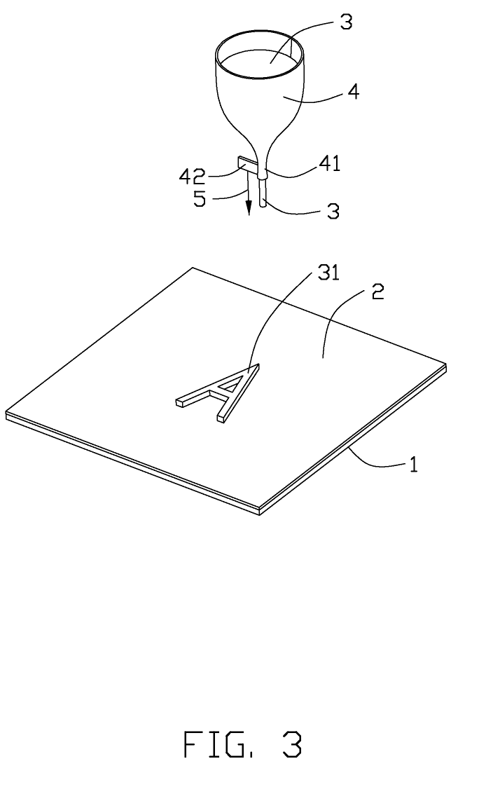

Following presentation the method of producing the waveguide, referring to FIG. 1, said substrate 1 coating a layer of resin and shining UV lights on the substrate to form the clad 2. Referring to FIGS. 2, the container 4 defines a nozzle 41 inject waveguide material 3, said container 4 through the nozzle 41 inject waveguide material 3 to the clad 2 and shining UV lights on the waveguide material 3 for hardening the waveguide material to form a waveguide pattern 31, said UV lights moves along with the nozzle 41. The nozzle at one side thereof defines a UV lights launcher 42, so that UV lights can move together with the nozzle at the same time. Of course, UV lights 5 also can cover with the area that the clad 2 limited. The user can define a route of the nozzle 41 so as to form the waveguide material to a required shape and finally, forming the waveguide pattern, such as an “A” shown on FIG. 3, said nozzle 41 of present invention is round shape.

According to the demand, the nozzle 41 of the container 4 can be designed into any shape, such as a round or a square shape and then a cross-section of the waveguide pattern 31 was round or square shape. Therefore, the shape of the nozzle 41 defines the cross-section shape of the waveguide pattern 31.

Once upon a time, the method for producing an optical waveguide usually comprising the following steps: providing a substrate and coating a layer of resin on the substrate to form a clad; providing waveguide material and coating it on the clad to form waveguide layer; providing a shielding blade which have an opening on the upper region of the waveguide layer; providing UV lights on the upper region of the shielding blade and the UV lights cross through the opening and shining on the waveguide layer for hardening the waveguide layer on the limited area to form waveguide pattern. In other words, the waveguide layer on outside area of the opening need to remove, this method for producing the optical waveguide waste of material and can not produce the optical waveguide on a curved surface.

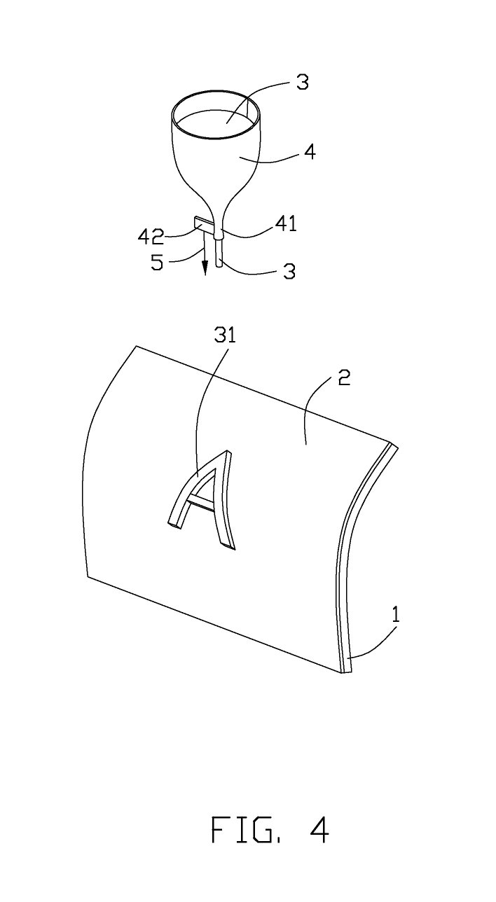

Referring to FIG. 4, said waveguide material 3 is injected through the nozzle 41, so that the optical waveguide can produce on the substrate even if the substrate is not a plane surface, such as a curved shape.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A method of producing an optical waveguide, comprising the steps of:
(a) providing a substrate and coating resins on the substrate to form a clad;
(b) providing a container filled with waveguide material and inject the waveguide material through a nozzle of the container to form a shape needed on the clad;
(c) providing UV lights and shining the UV lights on the waveguide material to harden the waveguide material to form the waveguide pattern.

2. A method of producing an optical waveguide according to claim 1, wherein route of the nozzle inject the waveguide material formed the waveguide pattern.

3. A method of producing an optical waveguide according to claim 2, wherein said nozzle is of round shape.

4. A method of producing an optical waveguide according to claim 3, wherein said UV lights moves along with the nozzle.

5. A method of producing an optical waveguide according to claim 3, wherein shine UV lights on the area of the clad when the nozzle inject the waveguide material.

6. A method of producing an optical waveguide according to claim 4, wherein said substrate present as a curved shape.

7. A method of producing an optical waveguide according to claim 6, wherein said container has an UV lights launcher formed at one side of the nozzle.

8. A method of producing n optical waveguide according to claim 5, wherein said substrate present as a curved shape.

9. A method of producing an optical waveguide according to claim 8, wherein said container has an UV lights launcher formed at one side of the nozzle.

10. A method of making an optical waveguide comprising steps of:
providing a substrate and coating resins thereon to form a clad;
applying waveguide material unto predetermined areas of the clad;
providing UV lights and shining said UV lights upon the waveguide material to harden the waveguide material for forming a specific waveguide pattern.

11. The method of making the optical waveguide as claimed in claim 10, wherein the step of applying waveguide material unto the predetermined areas of the clad is made by ejecting the waveguide material via a nuzzle which is associated with a container in which said waveguide material is received.

12. The method of making the optical waveguide as claimed in claim 11, where said nuzzle defines an inject configuration corresponding to the waveguide pattern.

13. The method of making the optical waveguide as claimed in claim 11, wherein the step of applying waveguide material unto the predetermined areas of the clad and the step of shining the UV light upon the waveguide material are taken simultaneously.

14. The method of making the optical waveguide as claimed in claim 11, wherein a source of said UV light moves along with the nuzzle when said nuzzle is moved.
